(19) United States
(12) Patent Application Publication
(10) Pub. No.: US 2013/0056473 A1
(43) Pub. Date: Mar. 7, 2013

(54) Water Supply for a Vehicle

(71) Applicant: Larry Hofer, Grosse Isle (CA)

(72) Inventor: Larry Hofer, Grosse Isle (CA)

(21) Appl. No.: 13/223,558

(22) Filed: Sep. 1, 2011

(51) Int. Cl. B60P 3/00

(52) U.S. Cl. 220/562

(57) ABSTRACT

Apparatus for providing a water supply for an agricultural vehicle includes an elongate cylindrical container for receiving water attached by straps to an exterior frame member of the vehicle at one side. A discharge pipe of the container has a valve at hand height for a user standing at the one side for discharge downwardly of water contained in the container. The container is supplied by a flexible pipe attached to a discharge nozzle of an air conditioning system of the vehicle to collect condensate therefrom.

This invention relates to a water supply for an agricultural vehicle where a container is provided which can be readily attached to the vehicle and which can receive a water supply from the air conditioning system of a cab of the vehicle.

According to one aspect of the invention there is provided an apparatus for providing a water supply for an agricultural vehicle comprising:

an elongate tubular container for receiving water;

a discharge pipe at a bottom of the container for discharge downwardly of water contained in the container;

a valve at the discharge pipe for controlling discharge of the water;

attachment members for attaching the container longitudinally along a frame member of the vehicle;

and a flexible pipe for attachment to a discharge nozzle of an air conditioning system of the vehicle to collect condensate therefrom.

Preferably the attachment members comprise straps for wrapping around the frame member.

Preferably the frame member is longer than the container.

Preferably the container is of circular cylindrical shape.

Preferably the container is closed at the upper end and includes an opening through which the pipe passes.

Preferably the air conditioning system is arranged in the cab of the vehicle so that the pipe depends downwardly from the cab to the upper end of the container.

Preferably the frame member is on the exterior of the vehicle at one side.

Preferably the container is arranged on the frame member so that the discharge pipe is at hand height when the user is standing on the vehicle at one side of the vehicle.

According to a second aspect of the invention there is provided a combination of a vehicle and a water supply for the vehicle comprising:

a vehicle with a frame carried on ground wheels, operating components on the frame, a cab on the frame, an air conditioning system for the cab and an elongate member of the frame exposed at a side of the frame;

the eater supply comprising:
an elongate tubular container for receiving water;
a discharge pipe at a bottom of the container for discharge downwardly of water contained in the container;
a valve at the discharge pipe for controlling discharge of the water;
attachment members attaching the container longitudinally along the exposed frame member of the vehicle;
and a flexible pipe attached to a discharge nozzle of the air conditioning system of the vehicle to collect condensate therefrom to carry it to the tubular container.

### BRIEF DESCRIPTION OF THE DRAWINGS

One embodiment of the invention will now be described in conjunction with the accompanying drawings in which:

FIG. 1 is a side elevational view of a water supply apparatus attached to an agricultural vehicle which is shown in the example as combine harvester.

In the drawings like characters of reference indicate corresponding parts in the different figures.

### DETAILED DESCRIPTION

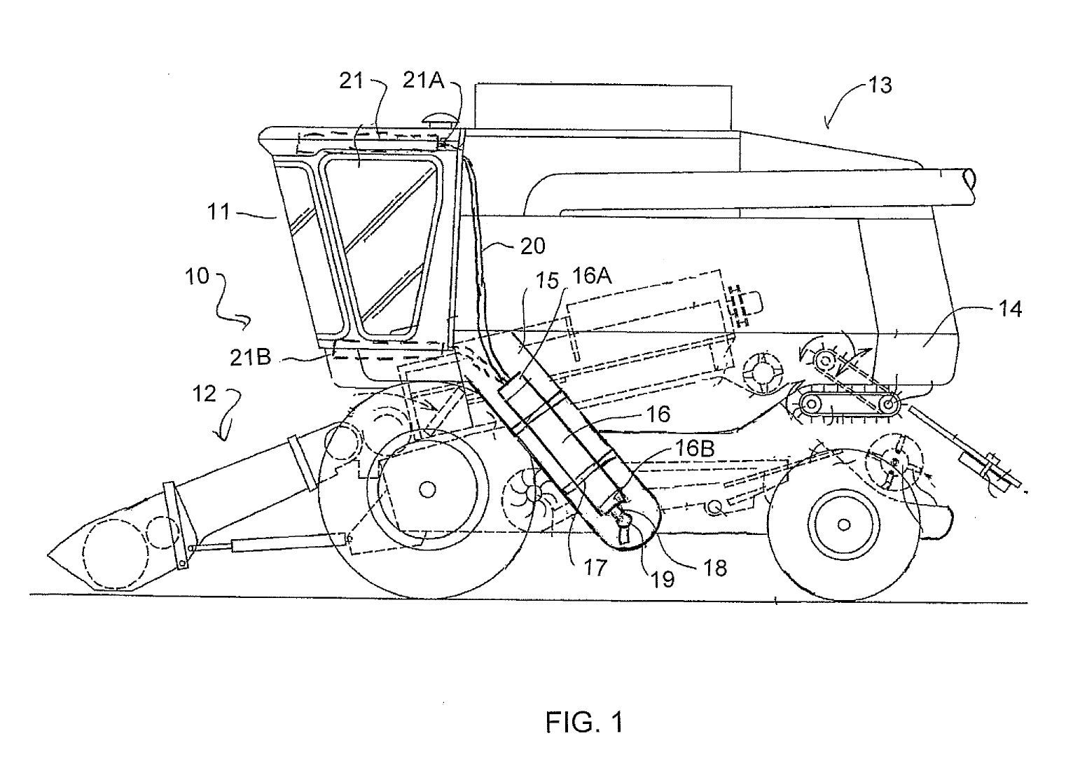

In FIG. 1 is shown a combine harvester 10 of a conventional construction which includes a cab 11, a pick-up or header 12 and a crop processing system 13 mounted in a frame 14. Further details of such constructions are readily available from many sources.

On to the agricultural vehicle or combine harvester 10 is mounted an apparatus for providing a water supply for the agricultural vehicle. This includes an elongate tubular cylindrical container 16 for receiving water. This is formed from a pipe of a plastics material which can use plumbing components to form top and bottom end caps 16A and 16B. A discharge pipe 18 is connected to the bottom cap 16A at a bottom of the container for discharge downwardly of water contained in the container. The tube 16 extends at an angle inclined downwardly and rearwardly along a frame member 15 of the vehicle. The discharge pipe therefore commences a the same angle and then turns vertically downwardly to a bottom opening to discharge water form the container downwardly to be used by a the driver for example for washing. As the water is not intended for drinking, it does not need to be filtered or cleaned and is suitable for washing and other similar uses such as cleaning related equipment.

A valve 19 is provided at or in the discharge pipe for controlling discharge of the water when required by the driver.

The tube 16 is connected longitudinally along the frame member 15 of the vehicle by attachment members such as straps 17 which wrap around the tube and clamp it to the outside surface of the exterior frame member 15. However other mounting arrangements may be used including brackets screwed to the frame member. The straps are particularly suitable in that they avoid the requirement for drilling or other fastening arrangement on the frame member 15 and can be arranged to attach to different types of combine or other vehicle and different locations thereon. The frame member selected is typically longer than the container so that it can lie flat against the outside surface without interfering with other components of the vehicle.

A flexible pipe is provided as part of the kit of parts for attachment to a discharge nozzle 21A of an air conditioning system 21 of the vehicle to collect condensate therefrom. The

The air conditioning system 21 is arranged in or on the cab of the vehicle so that the flexible pipe 20 depends downwardly from the cab to the upper end of the container and can be located in place by suitable ties.

The container is thus arranged on the frame member 15 so that the discharge pipe 18 is at hand height when the user is standing at the vehicle at one side of the vehicle. This allows the user to operate the valve and discharge required water at a convenient height while the discharge end of the pipe is below the air conditioning system even when located at the bottom of the cab as shown at 21B. In this way the condensate discharged from the air conditioning system simply falls by gravity to the location of the tank 16 and avoids any complexity or filtration systems.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for providing a water supply for a vehicle comprising:
an elongate tubular container for receiving water;
a discharge pipe at a bottom of the container for discharge downwardly of water contained in the container;
a valve at the discharge pipe for controlling discharge of the water;
attachment members for attaching the container longitudinally along a frame member of the vehicle;
and a flexible pipe for attachment to a discharge nozzle of an air conditioning system of the vehicle to collect condensate therefrom.

2. The apparatus according to claim 1 wherein the attachment members comprise straps for wrapping around the frame member.

3. The apparatus according to claim 1 wherein the frame member is longer than the container.

4. The apparatus according to claim 1 wherein the container is of circular cylindrical shape.

5. The apparatus according to claim 1 wherein the container is closed at the upper end and includes an opening through which the pipe passes.

6. The apparatus according to claim 1 wherein the air conditioning system is arranged in the cab of the vehicle so that the pipe depends downwardly from the cab to the upper end of the container.

7. The apparatus according to claim 1 wherein the frame member is on the exterior of the vehicle at one side.

8. The apparatus according to claim 1 wherein the container is arranged on the frame member so that the discharge pipe is at hand height when the user is standing at the vehicle at one side of the vehicle.

9. A combination of a vehicle and a water supply for the vehicle comprising:
a vehicle with a frame carried on ground wheels, operating components on the frame, a cab on the frame, an air conditioning system for the cab and an elongate member of the frame exposed at a side of the frame;
the eater supply comprising:
an elongate tubular container for receiving water;
a discharge pipe at a bottom of the container for discharge downwardly of water contained in the container;
a valve at the discharge pipe for controlling discharge of the water;
attachment members attaching the container longitudinally along the exposed frame member of the vehicle;
and a flexible pipe attached to a discharge nozzle of the air conditioning system of the vehicle to collect condensate therefrom to carry it to the tubular container.

10. The combination according to claim 9 wherein the attachment members comprise straps wrapping around the frame member.

11. The combination according to claim 9 wherein the frame member is longer than the container.

12. The combination according to claim 9 wherein the container is of circular cylindrical shape.

13. The combination according to claim 9 wherein the container is closed at the upper end and includes an opening through which the pipe passes.

14. The combination according to claim 9 wherein the air conditioning system is arranged in the cab of the vehicle so that the pipe depends downwardly from the cab to the upper end of the container.

15. The combination according to claim 9 wherein the container is arranged on the frame member so that the discharge pipe is at hand height when the user is standing at the vehicle at one side of the vehicle.

16. The combination according to claim 9 wherein the vehicle is an agricultural vehicle for operating on crops.
